(19) United States
(12) Patent Application Publication
(10) Pub. No.: US 2010/0178037 A1
(43) Pub. Date: Jul. 15, 2010

(54) DISPLAY APPARATUS, VIDEO GENERATION APPARATUS, AND METHOD THEREOF

(76) Inventors: Te-Wei Chen, Taipei City (TW); Chi-Chin Lien, Taipei City (TW); Hui-Cheng Hsu, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 12/351,864

(22) Filed: Jan. 12, 2009

(51) Int. Cl. H04N 7/26; H04N 5/00

(52) U.S. Cl. 386/109; 386/126; 386/E05.064

(57) ABSTRACT

A video generation apparatus for processing a video source to generate a video stream supplied to a display apparatus comprises: a buffer and a scaler. The buffer is capable of storing scaling reference lines retrieved from the video source. The scaler is used for generating scaled lines based on the scaling reference lines stored in the buffer, wherein the scaled lines are used in the video stream supplied to the display apparatus, and an input line period length of the scaler receiving the video source and an output line period length of the scaler supplying the video stream to the display apparatus are the same. Valid scaled lines generated for each frame by the scaler is less than a total number of output line periods for each frame of the video stream.

### BACKGROUND

The invention is related to video processing, and more particularly related to scaling processing in video processing.

Format conversion is usually necessary when two machines need to cooperate. When a movie is to be played on a television with a DVD player, no matter what resolution of video is defined by an optical disc, the DVD player needs to generate a video output with a format consistent with resolution requirements of the television. For example, a video source with images of 576 resolution lines needs to be either discarded 96 lines or scaled to fit in a display apparatus that can only display 480 resolution lines. Discarding lines directly causes poor quality, but scaling brings higher cost and complexity of design.

Therefore, it is desirable to design a video generation apparatus and corresponding display apparatus providing better image quality while reducing design complexity and cost.

### SUMMARY OF THE DISCLOSURE

According to a first embodiment of the invention, a video generation apparatus for processing a video source to generate a video stream supplied to a display apparatus is disclosed. The video generation apparatus comprises a buffer and a scaler. The buffer is capable of storing scaling reference lines retrieved from the video source. The scaler is used for generating scaled lines based on the scaling reference lines stored in the buffer, wherein the scaled lines are used in the video stream supplied to the display apparatus, and an input line period length of the scaler receiving the video source and an output line period length of the scaler supplying the video stream to the display apparatus are the same. Valid scaled lines generated for each frame by the scaler is less than a total number of output line periods for each frame of the video stream.

According to a second embodiment of the invention, a video generation method comprises the steps: receiving a video source with an input line period length; buffering scaling reference lines retrieved from the video source; generating scaled lines based on the buffered scaling reference lines; and outputting scaled lines with an output line period length to be used in a video stream, wherein the input line period length and the output line period length are the same, and valid scaled lines generated for each frame is less than a total number of output line periods for each frame of the video stream.

According to a third embodiment of the invention, a display apparatus for receiving a video stream generated by a video generation apparatus is disclosed. The display apparatus comprises a panel, a renderer, and a pause controller. The renderer is used for rendering the video stream to be displayed on the panel. The pause controller is used for controlling the renderer to pause rendering in a number of scan line periods for each frame of the video stream based on a preset scheme, wherein the preset scheme is also used by the video generation apparatus for defining the number of scan line period in each frame when valid scan line is not available.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an application based on the invention.

FIG. 2 illustrates an exemplary video generation apparatus.

FIG. 3 illustrates two schemes for scaling and generating pause signals.

FIG. 4 illustrates a timing diagram example.

FIG. 5 illustrates another timing diagram example.

FIG. 6 illustrates yet another timing diagram example.

FIG. 7 illustrates a display apparatus that contains the preset scheme inside.

FIG. 8 illustrates a flowchart of a method for scaling.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

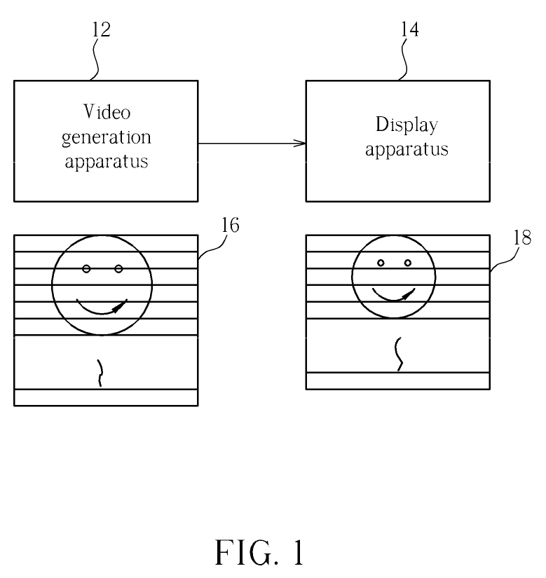

FIG. 1 is a diagram illustrating an application according to the invention. A video generation apparatus 12, e.g. a DVD player, supplies a video stream to a display apparatus 14, e.g. a television. The video stream is generated by scaling a video source. Each frame 16 in the video source has more scan lines than each frame 18 does in the video stream. For example, there are six scan lines in the frame 16 illustrating a smiling face, but there are only five scan lines in the frame 18 illustrating the smiling face. Instead of skipping one line while rendering the smiling face in the display apparatus 14, the video source is scaled by the video generation apparatus 12 while generating the video stream supplied to the display apparatus 14.

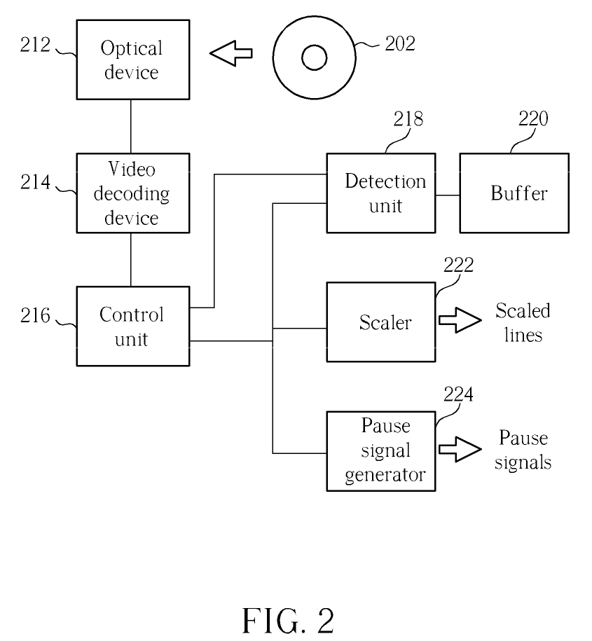

FIG. 2 illustrates an exemplary video generation apparatus that generates scaled lines and pause signals in a video stream to a corresponding display apparatus. The exemplary video generation apparatus contains an optical device 212, a video decoding device 214, a control unit 216, a detection unit 218, a buffer 220, a scaler 222, and a pause signal generator 224. The optical device 212 is used for reading video information recorded on an optical disc 202. The video information is decoded by the video decoder device 214 to generate a video source. Alternatively, the optical device 212 may be replaced with a hard disk or any storage storing video information locally or remotely. For example, a tiny portable MP4 player or a home media center server may produce the video source to be further processed by the components explained as follows.

The video source is scaled by the scaler 222 to produce the scaled lines. To simply the design of the scaler, which consequently reduces total cost and complexity of the video generation apparatus design, the input line period length of the scaler 222 receiving the video source is the same as the output line period length of the scaler 222 supplying the video stream to the display apparatus. When the video source has more scan lines for each frame than the video stream does, there are a number of output line periods of the scaler in which no valid scaled line are generated. In other words, valid scaled lines generated for each frame is less than a total number of output line periods for each frame of the video stream. The pause signals are therefore generated to inform the display apparatus when to pause rendering the video stream because the video stream does not always contain necessary valid scaled lines in every output line period.

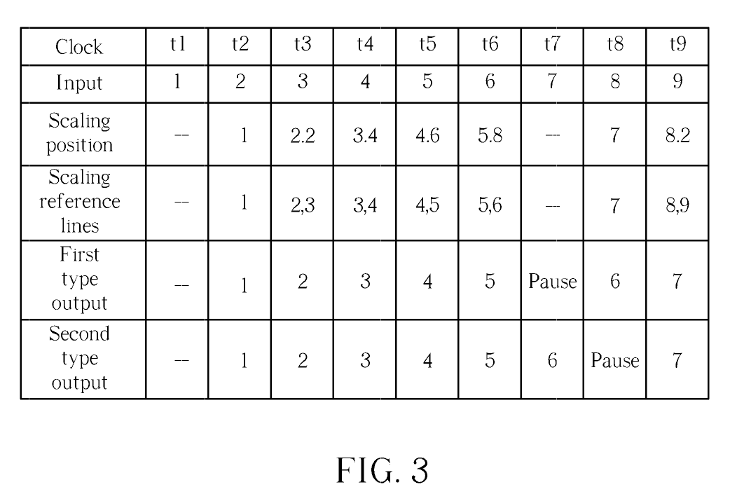

FIG. 3 illustrates an example for performing a 6:5 scaling, which means 6 scan lines are scaled into corresponding 5 scan lines, such as the frame 16 being scaled into the frame 18 as shown in FIG. 1. In the following, FIG. 2 and FIG. 3 are used together for explaining when the pause signals are generated along with the scaling process.

In clock “t1”, a first scan line “1” of the video source arrives in the buffer 220. In clock “t2”, the first scan line “1” stored in the buffer 220 is directly output as corresponding scaled line “1”. In addition, a second scan line “2” arrives in the buffer 220 in clock “t2”. In clock “t3”, a third scan line “3” also arrives in the buffer 220. The scaled line “2”, which needs to reference two scaling reference lines, scan lines “2” and “3”, now can be generated. Besides, since the scaled line “2” is supposed to appear at the scaling position “2.2”, the scaling position determines corresponding weightings of scaling reference lines “2” and “3”. Various scaling algorithms may be used for scaling. For example, multiplying 0.8 to the scaling reference line “2” and multiplying 0.2 to the scaling reference line “3” before adding the multiplied results is an easy way to generate the scaled line “2”. To achieve better scaling result, more than two scaling reference lines as well as other scaling algorithms may also be used for generating a scaled line.

Then, in clocks “t4”, “t5” and “t6”, the scaler 222 continues to generate scaled lines “3”, “4” and “5” respectively. In clock “t7”, the scaled line “6” may be generated because necessary scaling reference line “7” has arrived. In clock “t9”, however, the next scaled line “7” needs to reference to scaling reference lines “8, 9” but the scaling reference line “9” has not arrived in clock “t9”. In other words, in 6:5 scaling, a clock needs to be waited for each 7 lines. Therefore, a pause signal is generated by the pause signal generator 224 either in clock “t7” or in clock “t8”, i.e. the two schemes of “First Type Output” and “Second Type Output” illustrated in FIG. 3.

In actual designs, the control unit 216 may record a preset scheme in advance. The preset scheme defines when to output a pause signal. For example, in the 6:5 scaling example illustrated above, a pause signal should be generated per 7 clocks. Alternatively, a detection unit 218 may be installed for detecting the buffer 220 to check whether associated scaling reference lines all arrive in the buffer 220. If there is one or more than one scale reference lines have not arrived to the buffer 220 yet, the pause signal generator 224 may be triggered to output a pause signal.

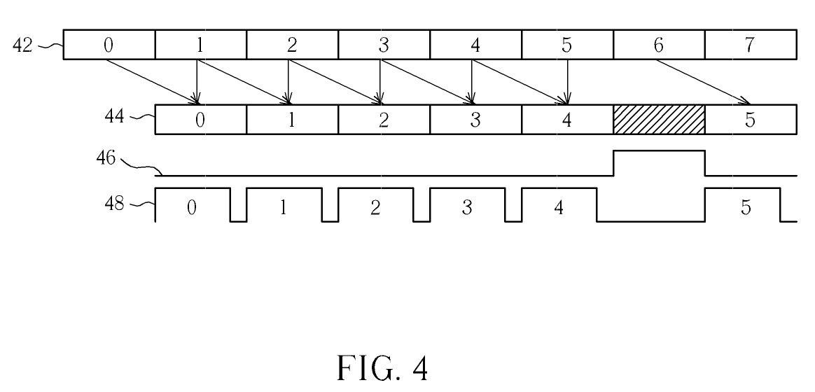

FIG. 4 is a diagram illustrating dependency relationship between input scan lines 42 of a video source and output scan lines 44 of a video stream as well as pause signals 46 and display apparatus enabling signals 48. In FIG. 4, it is also a 6:5 scaling. In this example, an input scan line “6” is used as the scaling reference line for generating output scan line “5”, a pause signal 46 is therefore generated that causes the display apparatus that receives the pause signal 46 to disable for a clock in the display enabling signals 48. The above example can be used for a 576 lines to 480 lines scaling.

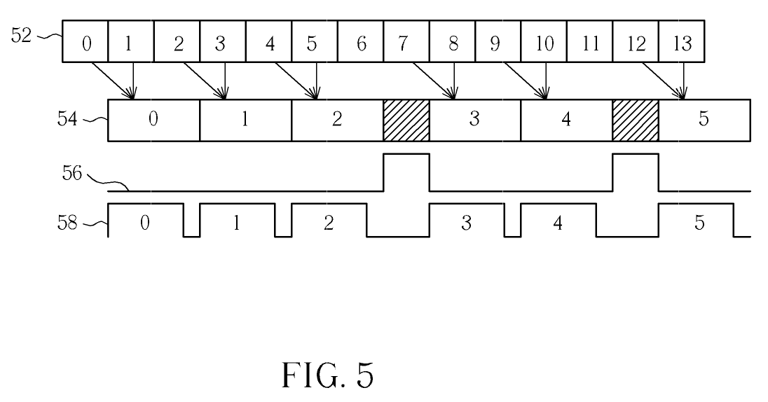

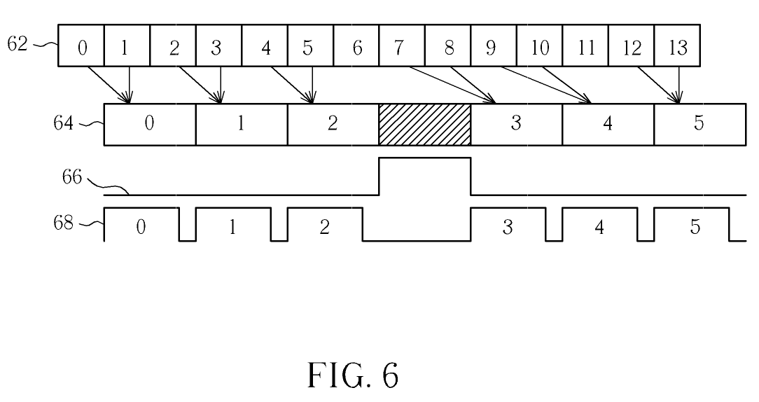

FIG. 5 and FIG. 6 illustrate two schemes in an interlaced mode scaling. In contrast with progressive mode interlacing as explained above, pause signals usually need to be produced more frequently in the interlaced mode scaling, because an image frame is divided into two field frames. FIG. 5 illustrates the relationship between the input scan lines 52 and the output scan lines 54. In the periods when the input scan lines “7” and “12” arrive, pause signals 56 are generated separately, which consequently cause a corresponding display apparatus to disable rendering a received video stream by setting video enabling signals 58. Similarly, FIG. 6 illustrates another scheme of generation of pause signals 66 and corresponding display enabling signals 68 of a display apparatus. In this scheme, two pause signals 66 are generated together, instead of being generated separately in FIG. 5, for waiting long enough for 13 input scan lines 62.

In the above examples, a display apparatus receives pause signals for determining when to pause rendering a received video stream. With knowledge of which output line periods do not contain valid scaled lines for each frame, however, the pause signals may even be skipped. Once a display apparatus knows the preset scheme defining when valid scaled lines exist, the display apparatus may stop rendering the input stream in proper output line periods. If the display apparatus knows when to the pause rendering, a corresponding video generation apparatus may also reduce associated pause signal generator.

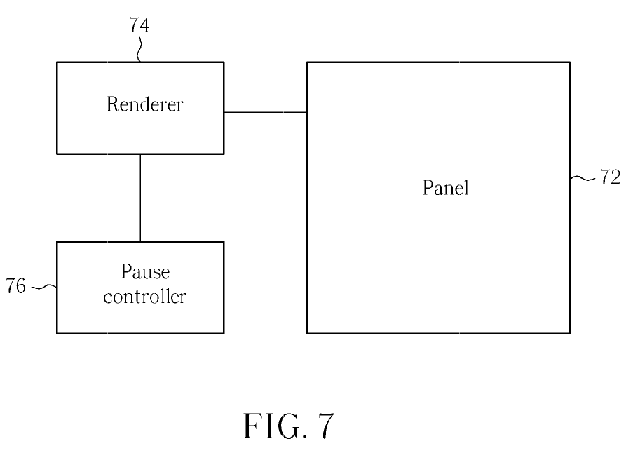

FIG. 7 illustrates a display apparatus that knows the preset scheme that is used by a corresponding video generation apparatus. The display apparatus has a panel 72, a renderer 74, and a pause controller 76. The renderer 74 renders a video stream on the panel 72. The pause controller 76 controls the renderer 74 to pause rendering in a number of scan line periods for each frame of the video stream based on a preset scheme. The preset scheme is also used by a corresponding video generation apparatus for defining the number of scan line periods in each frame when a valid scan line is available or not available. Such display apparatus can use an interlaced mode panel or a progressive mode panel. Besides, a video source in the video generation apparatus has more scan lines in each frame than the video stream does.

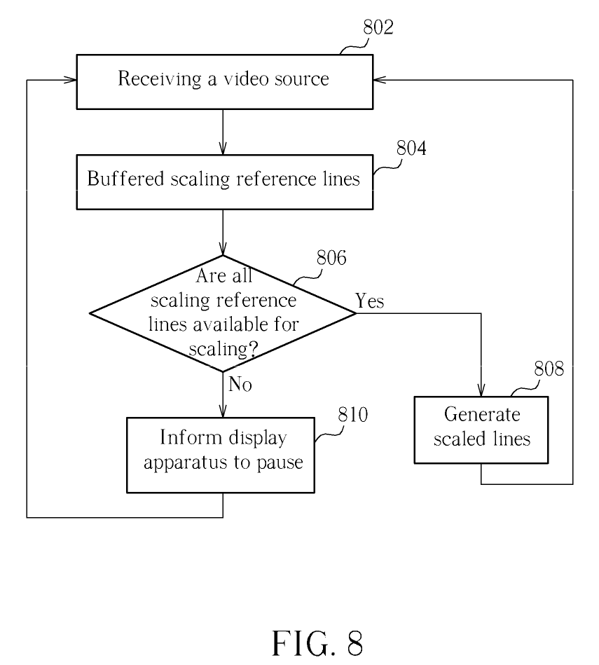

FIG. 8 illustrates a flowchart of a video generation method. First, a video source is received (step 802), e.g. from an optical disc or decoded from an Internet video server. Scaling reference lines of the video source are stored in a buffer (step 804) so as to be used in scaling operation. It is then determined whether all necessary scaling reference lines are already buffered (step 806). If necessary scaling reference lines are already in the buffer, scaled lines are generated (step 808). Otherwise, a display apparatus is informed to pause rendering a video stream that contain the scaled lines (step 810). The output line period length to be used in the video stream and the input period length to receive the video source are the same, so that valid scaled lines generated for each frame is less than a total number of output line periods for each frame of the video stream.

The examples explained above may reduce the design complexity and consequently reduce cost of the whole system when the input line period length of a scaler is the same as output line period length of the scaler.

Besides, the “video generation apparatus” may refer to contain even only a scaler which contains a portion of buffer inside the scaler and another portion of buffer outside the scaler. When the term “buffer” is used, the “buffer” may be distributed in several storage units. For example, when a line just arrives from the video source, the total line may be stored or only a current pixel necessary for scaling is stored. For an input line that needs not be scaled, the input line may be output directly without any scaling operation. Furthermore, the components mentioned above, such like “buffer”, “scaler”, “detection unit”, “control unit” and “pause signal generator” may be implemented totally in hardware circuits or be implemented with any types of hardware and software combination. General purpose processors may be used or specific circuits may be designed for achieving the function of scaling, buffer detection, pause signal generation, etc.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A video generation apparatus for processing a video source to generate a video stream supplied to a display apparatus, the video generation apparatus comprising:
a buffer, capable of storing scaling reference lines retrieved from the video source; and
a scaler, for generating scaled lines based on the scaling reference lines stored in the buffer, wherein the scaled lines are used in the video stream supplied to the display apparatus, and an input line period length of the scaler receiving the video source and an output line period length of the scaler supplying the video stream to the display apparatus are the same;
wherein valid scaled lines generated for each frame by the scaler is less than a total number of output line periods for each frame of the video stream.

2. The video generation apparatus of claim 1, further comprising a pause signal generator for outputting pause signals to indicate the display apparatus when to pause rendering the video stream in a number of output line periods for each frame of the video stream.

3. The video generation apparatus of claim 2, wherein the pause signal generator outputs the pause signals when the scaler is unable to generate the scaled lines because the associated scaling reference lines do not all arrive in the buffer yet.

4. The video generation apparatus of claim 3, further comprising a detection unit coupled to the scaler for detecting whether the associated scaling reference lines all arrive in the buffer.

5. The video generation apparatus of claim 2, further comprising a control unit coupled to the scaler and the pause signal generator for determining when to generate the scaled lines and when to output the pause signals based on a preset scheme.

6. The video generation apparatus of claim 2, wherein the video source has more scan lines in each frame than the video stream does.

7. The video generation apparatus of claim 6, wherein the video stream is of progressive scanning mode.

8. The video generation apparatus of claim 7, wherein the video source has 576 scan lines and the video stream has 480 scan lines for each frame.

9. The video generation apparatus of claim 6, wherein the video stream is of interlaced mode.

10. The video generation apparatus of claim 1, further comprising a video decoding device for generating the video source.

11. The video generation apparatus of claim 10, further comprising an optical device for reading video information from an optical disc and for supplying the video information to the video decoding device for generating the video source.

12. A video generation method, comprising:
receiving a video source with an input line period length;
buffering scaling reference lines retrieved from the video source;
generating scaled lines based on the buffered scaling reference lines; and
outputting scaled lines with an output line period length to be used in a video stream, wherein the input line period length and the output line period length are the same, and valid scaled lines generated for each frame is less than a total number of output line periods for each frame of the video stream.

13. The video generation method of claim 12, further comprising:
generating pause signals to inform a display apparatus when to pause rendering the video stream in a number of output line periods for each frame.

14. The video generation method of claim 13, wherein the pause signals are generated when the associated scaling reference lines do not all arrive in a buffer yet.

15. The video generation method of claim 12, wherein the video source has more scan lines in each frame than the video stream does.

16. The video generation method of claim 12, further comprising:
reading an optical disc for retrieving and decoding video information to construct the video source.

17. A display apparatus for receiving a video stream generated by a video generation apparatus, the display apparatus comprising:
a panel;
a renderer, for rendering the video stream to be displayed on the panel; and
a pause controller, for controlling the renderer to pause rendering in a number of scan line periods for each frame of the video stream based on a preset scheme, wherein the preset scheme is also used by the video generation apparatus for defining the number of scan line period in each frame when valid scan line is not available.

18. The display apparatus of claim 17, wherein the panel is a progressive mode display device.

19. The display apparatus of claim 17, wherein the panel is an interlaced mode display device.

20. The display apparatus of claim 17, wherein the video source has more scan lines in each frame than the video stream does.
